(19) United States
(12) Patent Application Publication
(10) Pub. No.: US 2006/0259967 A1
(43) Pub. Date: Nov. 16, 2006

(54) Proactively protecting computers in a networking environment from malware

(75) Inventors: Anil Francis Thomas, Redmond, WA (US); Michael Kramer, Yonkers, NY (US); Mihai Costea, Redmond, WA (US); Pradeep Bahl, Redmond, WA (US); Rajesh K. Dadhia, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/129,695

(22) Filed: May 13, 2005

(51) Int. Cl. G06F 12/14

(52) U.S. Cl. 726/22

(57) ABSTRACT

In accordance with the present invention, a system, method, and computer-readable medium for sharing information between computers, computing devices, and computing systems in a networking environment to determine whether a network is under attack by malware is provided. In instances when the network is under attack, one or more restrictive security policies that protect computers and/or resources available from the network are implemented.

### FIELD OF THE INVENTION

The present invention relates to computers and, more particularly, to proactively protecting one or more networked computers, in real-time, from malware.

### BACKGROUND OF THE INVENTION

As more and more computers and other computing devices are interconnected through various networks such as the Internet, computer security has become increasingly more important, particularly from attacks delivered over a network. As those skilled in the art and others will recognize, these attacks come in many different forms, including, but certainly not limited to, computer viruses, computer worms, Trojans, system component replacements, denial of service attacks, even misuse/abuse of legitimate computer system features—all of which exploit one or more computer system vulnerabilities for illegitimate purposes. While those skilled in the art will realize that the various computer attacks are technically distinct from one another, for purposes of the present invention and for simplicity in description, all of these attacks will be generally referred to hereafter as computer malware or, more simply, malware.

When a computer system is attacked or “infected” by a computer malware, the adverse results are varied--including disabling system devices; erasing or corrupting firmware, operating system code, applications, or data files; transmitting potentially sensitive data to another location on the network; shutting down the computer system; or causing the computer system to crash. Yet another pernicious aspect of many, though not all, computer malware is that an infected computer system is used to infect other computer systems.

FIG. 1 is a pictorial diagram illustrating an exemplary networking environment 100 over which a computer malware is commonly distributed. As shown in FIG. 1, the typical exemplary networking environment 100 includes a plurality of computers 102-108, all interconnected via a communication network 110, such as an intranet, or via a larger communication network including the global TCP/IP network commonly referred to as the Internet. For whatever reason, a malicious party on a computer connected to the network 110—such as computer 102—develops a computer malware 112 and releases it on the network 110. The released computer malware 112 is received by and infects one or more computers, such as computer 104 as indicated by arrow 114. As is typical with many computer malware, once infected, computer 104 is used to infect other computers, such as computer 106 as indicated by arrow 116, which in turn, infects yet other computers, such as computer 108 as indicated by arrow 118.

As vulnerabilities are identified and addressed in an operating system or other computer system components such as device drivers and software applications, the operating system provider will typically release a software update to remedy the vulnerability. These updates, frequently referred to as patches, should be installed on a computer system in order to secure the computer system from the identified vulnerabilities. However, these updates are, in essence, code changes to components of the operating system, device drivers, or software applications. As such, they cannot be released as rapidly and freely as antivirus software updates from antivirus software providers. Because these updates are code changes, the software updates require substantial in-house testing prior to being released to the public.

Under the present system of identifying malware and addressing vulnerabilities, computers are susceptible to being attacked by malware in certain circumstances. For example, a computer user may not install patches and/or updates to antivirus software. In this instance, malware may propagate on a network among computers that have not been adequately protected against the malware. However, even when a user regularly updates a computer, there is a period of time, referred to hereafter as a vulnerability window, that exists between when a new computer malware is released on the network and when antivirus software or an operating system component may be updated to protect the computer system from the malware. As the name suggests, it is during this vulnerability window that a computer system is vulnerable, or exposed, to the new computer malware.

FIG. 2 is a block diagram of an exemplary timeline that illustrates a vulnerability window. In regard to the following discussion, significant times or events will be identified and referred to as events in regard to a timeline. While most malware released today are based on known vulnerabilities, occasionally, a computer malware is released on the network 110 that takes advantage of a previously unknown vulnerability. FIG. 2 illustrates a vulnerability window 204 with regard to a timeline 200 under this scenario. Thus, as shown on the timeline 200, at event 202 a malware author releases a new computer malware. As this is a new computer malware, there is neither an operating system patch nor an antivirus update available to protect vulnerable computer systems from the malware. Correspondingly, the vulnerability window 204 is opened.

At some point after the new computer malware is circulating on the network 110, the operating system provider and/or the antivirus software provider detects the new computer malware, as indicated by event 206. As those skilled in the art will appreciate, typically, the presence of the new computer malware is detected within a matter of hours by both the operating system provider and the antivirus software provider.

Once the computer malware is detected, the antivirus software provider can begin its process to identify a pattern or “signature” by which the antivirus software may recognize the computer malware. Similarly, the operating system provider begins its process to analyze the computer malware to determine whether the operating system must be patched to protect the computer from the malware. As a result of these parallel efforts, at event 208 the operating system provider and/or the antivirus software provider releases an update, i.e., a software patch, to the operating system or antivirus software that addresses the computer malware. Subsequently, at event 210 the update is installed on a user's computer system, thereby protecting the computer system and bringing the vulnerability window 204 to a close.

As can be seen from the examples described above—which are only representative of all of the possible scenarios in which computer malware pose security threats to a computer system—a vulnerability window 204 exists between the times that a computer malware 112 is released on a network 110 and when a corresponding update is installed on a user's computer system. Sadly, whether the vulnerability window 204 is large or small, an infected computer costs the computer's owner substantial amounts of money to “disinfect” and repair. This cost can be enormous when dealing with large corporations or entities that may have thousands or hundreds of thousands of devices attached to the network 110. Such a cost is further amplified by the possibility that the malware may tamper with or destroy user data, which may be extremely difficult or impossible to remedy.

Currently available antivirus systems search for positive indicators of malware or instances in which malware may be identified with a very high degree of certainty. For example, some antivirus software searches for malware signatures in incoming data. When a signature is identified in the incoming data, the antivirus software may declare, with a very high degree of certainty, that the incoming data contains malware. However, generating a malware signature and updating antivirus software to identify the malware is a time-consuming process. As a result, as described above with reference to FIG. 2, a vulnerability window 204 exists between the time a malware is released on a network and the time a remedy that identifies and/or prevents the malware from infecting network-accessible computers is created and installed. Moreover, as a result of advances in modem networks, malware may be highly prolific in spreading among the network-accessible computers. As a result, an update to antivirus software may not be available until most, if not all, of the network accessible computers have already been exposed to the malware.

### SUMMARY OF THE INVENTION

The foregoing problems with the state of the prior art are overcome by the principles of the present invention, which are directed toward a system, method, and computer-readable medium for sharing information between computers, computing devices, and computing systems to determine whether a network is under attack by malware. In instances when the network is under attack, one or more restrictive security policies that protect computers and/or resources available on the network are implemented.

In accordance with one aspect of the present invention, when an excessive amount of suspicious activity that may be characteristic of malware is identified, computers and/or resources in a networking environment enter one of a number of possible security levels that provide proactive protection against malware. In this regard, a method is provided that is configured to use a plurality of event detection systems in a network to observe and evaluate suspicious activity that may be characteristic of malware. More specifically, the method comprises (1) using event detection systems in a network to observe suspicious events that are potentially indicative of malware; (2) determining whether the suspicious events observed are indicative of malware; and (3) if the suspicious events observed are indicative of malware, applying a restrictive security policy in which access to resources or the ability of a computer to communicate over the network is restricted.

In accordance with another aspect of the present invention, a method of determining whether suspicious events observed in a networking environment are indicative of malware is provided. In one embodiment of the method, a value is assigned to each suspicious event observed based on the probability that the suspicious event is characteristic of malware. Then a summation of the values assigned to the suspicious events observed is generated. The summation is compared to a predetermined threshold in order to determine whether the suspicious events are characteristic of malware. In another embodiment, patterns of events that occur when a network is under attack by malware are identified. Then suspicious events that were actually observed are compared to the patterns of events that are known to be characteristic of malware. If the suspicious events observed match a pattern of events that is known to be characteristic of malware, then one or more restrictive security policies that protect computers and/or resources available on the network are implemented.

In yet another aspect of the present invention, a software system is provided that proactively protects a network from malware by implementing a restrictive security policy when the suspicious events observed rise above a predetermined threshold. In one embodiment, the software system includes a plurality of event detection systems, an evaluation component, a collector module, and a policy implementor. The collector module obtains data from an event detection system when a suspicious event is observed. At various times, the evaluation component makes a determination regarding whether data collected by the data collector component, taken as a whole, indicates that a network is under attack by malware. If the evaluation component determines that a malware attack is occurring, the policy implementor imposes a restrictive security policy.

In still yet another aspect of the present invention, a computer-readable medium is provided with contents, i.e., a program that causes a computer to operate in accordance with the methods described herein.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating a conventional networking environment over which malware is commonly distributed;

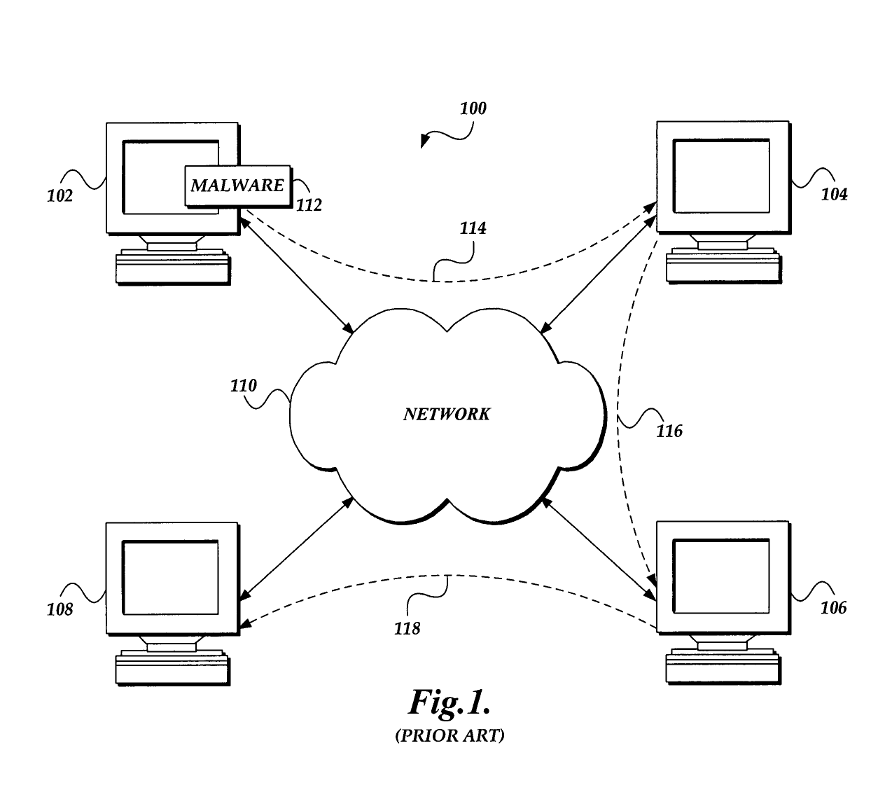

FIG. 2 is a block diagram illustrating an exemplary timeline that demonstrates how a vulnerability window may occur in the prior art;

FIG. 3 is a pictorial diagram of an exemplary networking environment in which aspects of the present invention may be implemented;

FIG. 4 is a block diagram illustrating components of an event evaluation computer depicted in FIG. 3 that is operative to proactively protect a networking environment from malware using a plurality of event detection systems, in accordance with the present invention;

FIG. 5 is a pictorial diagram of an exemplary networking environment in which aspects of the present invention may be implemented; and

FIG. 6 is a flow diagram illustrating one embodiment of a method implemented in a networking environment that proactively protects computers, computing devices, and computing systems in the networking environment from malware, in accordance with the present invention.

### DETAILED DESCRIPTION

In accordance with the present invention, a system, method, and computer-readable medium for sharing information between computers, computing devices, and computing systems to determine whether a network is under attack by malware is provided. In instances when the network is under attack, one or more restrictive security policies that protect computers and/or resources available from the network are implemented. Generally described, the present invention provides protections in a computer networking environment that are similar to mechanisms designed to protect public health. For example, government agencies are constantly monitoring for new contagious diseases that threaten public health. If a disease is identified that severely threatens public health, a continuum of policies may be implemented to protect the public health. Typically, the restrictive nature of a policy implemented, in these circumstances, depends on the danger to the public health. For example, if a deadly and highly-contagious disease is identified, people stricken with the disease may be quarantined. Conversely, if a contagious disease is identified that merely causes a non-life-threatening illness, less severe policies will typically be implemented. The present invention functions in a similar manner to identify “suspicious” events that may be indicative of malware in a computer networking environment. If the probability that malware is infecting a computer on the network is high, the ability of the computer to communicate and thereby infect other computers is severely restricted. In instances when there is less of a probability that a malware infection exists, less restrictive policies will typically be implemented.

The following description first provides an overview of aspects of the present invention that may be implemented in a networking environment. Then a method for implementing the present invention is described. The illustrative examples provided herein are not intended to be exhaustive or to limit the invention to the precise forms disclosed. Similarly, any steps described herein may be interchangeable with other steps or combinations of steps in order to achieve the same result.

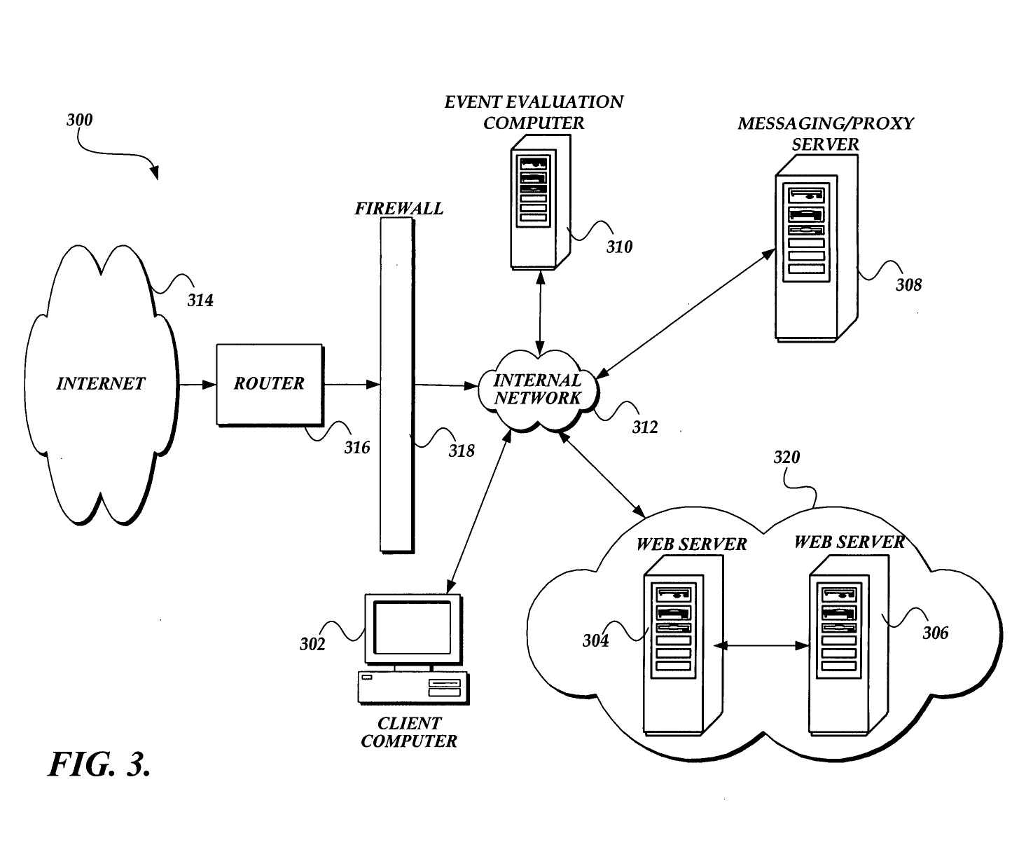

Referring to FIG. 3, the following is intended to provide an exemplary overview of one suitable networking environment 300 that will be used to describe aspects of the present invention. The illustrated networking environment 300 comprises a plurality of computers, including the client computer 302, the Web servers 304 and 306, the messaging/proxy server 308, and the event evaluation computer 310. As illustrated in FIG. 3, the computers 302, 304, 306, 308, and 310 are communicatively connected via the internal network 312. Those skilled in the art and others will recognize that the internal network 312 may be implemented as a local area network (“LAN”), wide area network (“WAN”), cellular network, IEEE 802.11 and Bluetooth wireless networks, and the like. Also, the computers 302, 304, 306, 308, and 310 are configured to communicate with computers and devices outside the internal network 312 via the Internet 314. In this regard, the networking environment 300 also includes a router 316 and a firewall 318. It should be noted that while the present invention is generally described in terms of operating in conjunction with personal computers, such as computer 302, it is for illustration purposes only and should not be construed as limiting upon the present invention. Those skilled in the art will readily recognize that almost any type of network or computer may be attacked by malware. Accordingly, the present invention may be advantageously implemented to protect numerous types of computers, computing devices, or computing systems, including, but not limited to, personal computers, tablet computers, notebook computers, personal digital assistants (PDAs), mini- and mainframe computers, network appliances, wireless phones (frequently referred to as cell phones), hybrid computing devices (such as wireless phone/PDA combinations), and the like. Moreover, the present invention may be used to protect other computers on the network than those illustrated and certain resources available from a network such as data, files, database items, and the like.

The networking environment 300 illustrated in FIG. 3 is characteristic of many enterprise-type networks created to service the needs of large organizations. Typically, an enterprise-type network will provide services to computers outside of the internal network 312. In this regard, the exemplary networking environment 300 includes Web servers 304 and 306 that collectively provide a service 320 that allows computers on the internal network 312 to publish resources to computers connected to the Internet 314. Moreover, the service 320 may be used to publish resources to computers connected to the internal network 312 (“Intranet”) using the same networking protocols that are used on the Internet. In any event, the servers 304 and 306 allow computers connected to the Internet 314 or the internal network 312 to access data (e.g., Web pages, files, databases, etc.). Since the Web servers 304 and 306 may accept queries from untrusted computers, the computers may be targets for attack by a malware author.

Most enterprise-type networks provide a service to users of an internal network for communicating using an asynchronous communication mechanism such as e-mail, instant messaging, two-way paging, and the like. As illustrated in FIG. 3, the networking environment 300 includes a messaging/proxy server 308 that allows computers connected to the internal network 312 to send and receive asynchronous communications to both computers on the internal network 312 and computers on the Internet 314. In this regard, asynchronous messages are routed through the messaging/proxy server 308 where they are forwarded to the correct destination using known communication protocols. Those skilled in the art and others will recognize that asynchronous communication mechanisms may be used to deliver malware. For example, a common distribution mechanism for malware is to include malicious program code in a file attached to an e-mail message. In this instance, a user will typically be misled into causing the malware to be “executed” by, for example, “double-clicking” on, or by selecting by other means, the file attachment that contains the malicious program code.

The networking environment 300 illustrated in FIG. 3 also includes a router 316. Those skilled in the art and others will recognize that the router 316 is a device that may be implemented in either hardware or software that determines the next point on a network in which a packet needs to be transmitted in order to reach the destination computer. The router 316 is connected to at least two networks and determines where to transmit a packet based on the configuration of the networks. In this regard, the router 316 maintains a table of the available paths that is used to determine the next point on a network that a packet will be transmitted.

The internal network 312 illustrated in FIG. 3 is typical of existing enterprise-type networks in that many components included in network 312 are configured to detect certain types of network activity. More generally, those skilled in the art and others will recognize that components of the internal network 312 may act as event detection systems that monitor network entry points, specific application and operating system events, data streams, and/or network events and activities. Collectively, events observed by these event detection systems may provide strong heuristic indicators that a malware is attempting to infect one or more computers connected to the internal network 312. Stated differently, by performing an analysis of data that describes events observed in a networking environment, anomalies to the typical pattern of network that are characteristic of malware may be identified.

The event detection systems that exist in a networking environment will typically maintain databases, event logs, and additional types of resources that record data regarding the events observed. For example, the router 316 may be configured to track the receipt of packets in a network traffic log. As a result, other software modules may query the network traffic log in order to monitor changes in network activity. Moreover, application programs on the messaging/proxy server 308 are configured to track asynchronous messages sent or received by computers connected to the internal network 312. A software module implemented by the present invention may obtain data from the messaging/proxy server 308 that describes the asynchronous messages transmitted over the network 312. By way of yet another example, the Web servers 304 and 306 satisfy requests for resources made from untrusted computers. Those skilled in the art and others will recognize that requests made to the Web servers 304 and 306 are available from an event log or similar event recording system.

Increasingly, operating systems installed on either stand-alone or computers in a network also maintain event detection systems. For example, some operating systems provide event detection systems designed to observe and record various operational events including performance metrics of a computer. In this regard, an event detection system may monitor CPU usage, the occurrence of page faults, termination of processes, and other performance characteristics of a computer. Events observed by this type of event detection system may provide strong heuristic indicators that a malware is attempting to infect a computer connected to the internal network 312.

Enterprise organizations commonly implement a security system on one or more gateway-type computers, such as the firewall 318. Those skilled in the art and others will recognize that a “firewall” is a general term used to describe one type of security system that protects an internal or private network from malware that is outside of the network. Generally described, existing firewalls analyze data that is being transmitted to computers inside a network in order to filter the incoming data. More specifically, some firewalls filter incoming data so that only packets that maintain certain attributes are able to be transmitted to computers inside the network. In some instances, a firewall is comprised of a combination of hardware and software or may be solely implemented in hardware.

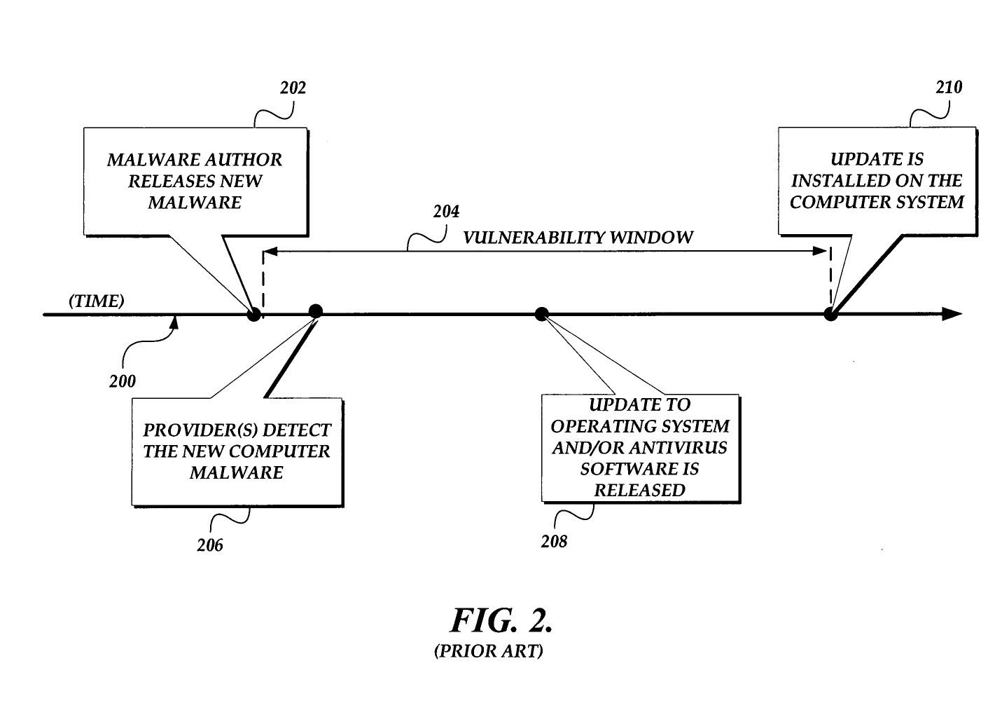

While the accuracy of security systems such as firewalls and antivirus software in detecting increasingly sophisticated malware has improved, these security systems have inherent limitations. For example, those skilled in the art and others will recognize that antivirus software needs to be regularly updated with the most recent malware signatures. However, many users and system administrators fail to update computers for a number of different reasons. Thus, while the most recent update to antivirus software may provide adequate protection from a newly discovered malware, a computer may not be “up to date” and, thus, be susceptible to malware. Also, as described above with reference to FIG. 2, even when a computer is maintained in an “up-to-date” state, a vulnerability window 204 exists between the time a malware is released on a network and when the appropriate software update is installed on a computer to handle the malware.

Even though existing security systems such as antivirus software and firewalls may not be able to positively detect malware in all instances, they may collect data or be easily configured to collect data that is a strong heuristic indicator of a malware attack or infection. For example, those skilled in the art and others will recognize that most malware is encrypted to avoid being detected in transit. By itself, encountering an encrypted file is not a positive indicator of malware. Instead, there are legitimate reasons why a file may be encrypted (e.g., the file was transmitted over a network connection that is not secure). If this type of event was used to positively identify a malware, a high number of “false positives” or instances when a malware was incorrectly identified would occur.

In addition to security systems, other event detection systems may collect data or be easily configured to collect data that is an heuristic indicator of a malware attack or infection. In the context of FIG. 3, a sharp increase in network activity detected by the router 316 or firewall 318, for example, may be a strong indicator of a malware infection or attack. Similarly, when the operating system installed on computers 302, 304, 306, 308, and 310 indicates that all or an increased percentage of the computers have a higher-than-normal usage of their CPU, this is another heuristic indicator of a malware infection or attack.

When software formed in accordance with the invention is implemented in one or more computers, such as the event evaluation computer 310, the computer 310 provides a way to collect data from disparate event detection systems in a network and determine whether the network is infected with or under attack by malware. Stated differently, aspects of the present invention collect heuristic indicators of malware at a central location in order to proactively protect a network from malware, even in instances when the exact nature of the malware is not known. In instances when the data collected indicates that the network is infected with or under attack by malware, a restrictive security policy is implemented. As described in further detail below, in some embodiments of the present invention, the restrictive security policy limits access to specified resources on the network. In other embodiments, the restrictive security policy limits the ability of computers on the network to use the network to communicate.

It should be well understood that the networking environment 300 illustrated in FIG. 3 should be construed as exemplary and not limiting. For example, the networking environment 300 may include other event detection systems and computers that are not described or illustrated with reference to FIG. 3. Instead, aspects of the present invention may collect heuristic indicators of a malware infection from other types of event detection systems and computers not described herein.

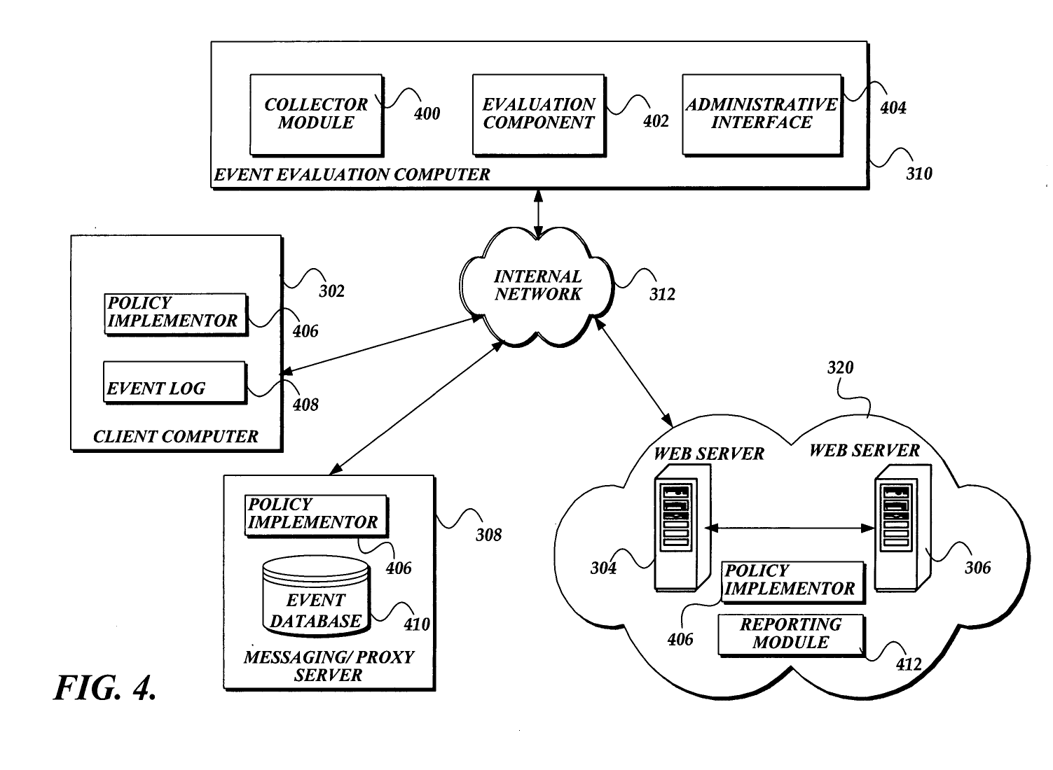

Now with reference to FIG. 4, components that are capable of implementing aspects of the present invention will be described. More specifically, software components and systems of the event evaluation computer 310, the computers 302, 304, 306, and 308 that illustrate aspects of the present invention will be described.

As mentioned previously, the computers 302, 304, 306, 308, and 310 may be any one of a variety of devices including, but not limited to, personal computing devices, server-based computing devices, mini- and mainframe computers, or other electronic devices having some type of memory. For ease of illustration and because it is not important for an understanding of the present invention, FIG. 4 does not show the typical components of many computers, such as a CPU, keyboard, a mouse, a printer, or other I/O devices, a display, etc. However, as illustrated in FIG. 4, the event evaluation computer 310 does include a collector module 400, an evaluation component 402, and an administrative interface 404. Also, the client computer 302 includes a policy implementor 406 and an event log 408. Similarly, the messaging/proxy server 308 includes a policy implementor 406 in addition to an event database 410. Lastly, the service 320 that is collectively performed by the Web servers 304 and 306 also includes the policy implementor 406 and a reporting module 412. It should be well understood that components of the computers 302, 304, 306, and 308, illustrated in FIG. 4 and described in further detail below (e.g. the policy implementor 406, the event log 408, the event database 410, and the reporting module 412) may be included with any computer, computing device, or computing system. For example, the router 316 and firewall 318 (not illustrated in FIG. 4) will have components for tracking and/or reporting suspicious events that may be characteristic of malware to the event evaluation computer 310. For simplicity in description, components for tracking and/or reporting suspicious events are illustrated in FIG. 4 as residing on specific computers. However, the location of these components should be construed as exemplary and not limiting since, in different embodiments of the present invention, the illustrated components may be located on other computers.

As mentioned above, the event evaluation computer 310 maintains a collector module 400. In general terms describing one embodiment of the present invention, the collector module 400 obtains data regarding “suspicious” events observed by disparate event detection systems in a network, which may be indicative of malware. The data collected may be merely an indicator from an event detection system that a suspicious event occurred. Alternatively, the collector module 400 may obtain metadata from an event detection system that describes attributes of a suspicious event. In either instance, the collector module 400 serves as an interface to event detection systems for obtaining data regarding suspicious events observed in a networking environment.

The event detection systems that observe events and communicate with the collector module 400 may be any one of a number of existing or yet-to-be-developed systems. For example, an event detection system may be a hardware device, an application program that may/may not be distributed over multiple computers, a component of an operating system, etc. Moreover, the collector module 400 may obtain data from the event detection systems in a number of different ways. In one embodiment of the present invention, the collector module 400 maintains an Application Program Interface (“API”) that allows software modules created by third-party providers to report suspicious events. In this instance, an event detection system created by a third party assists in identifying malware by issuing one or more API calls. In the context of FIG. 4, the service 320 maintains a reporting module 412 that is configured to report suspicious events to the collector module 400 by issuing one or more API calls. In accordance with an alternative embodiment, the collector module 400 actively obtains data that describes suspicious events from one or more resources maintained by an event detection system. For example, an event detection system may observe and record suspicious events in a database, event log, or other resource. In the context of FIG. 4, the collector module 400 may obtain data that describes suspicious events from the event log 408 maintained by the client computer 302 on the event database 410 maintained by the messaging/proxy server 308. While specific resources have been illustrated and described, these resources should be construed as exemplary and not limiting. For example, different types of computers, computing devices, and computing systems than those illustrated may maintain resources that are accessed by the collector module 400. Also, typically, a computer will maintain a plurality of resources in which events are recorded and/or data is made available to software routines that implement present invention.

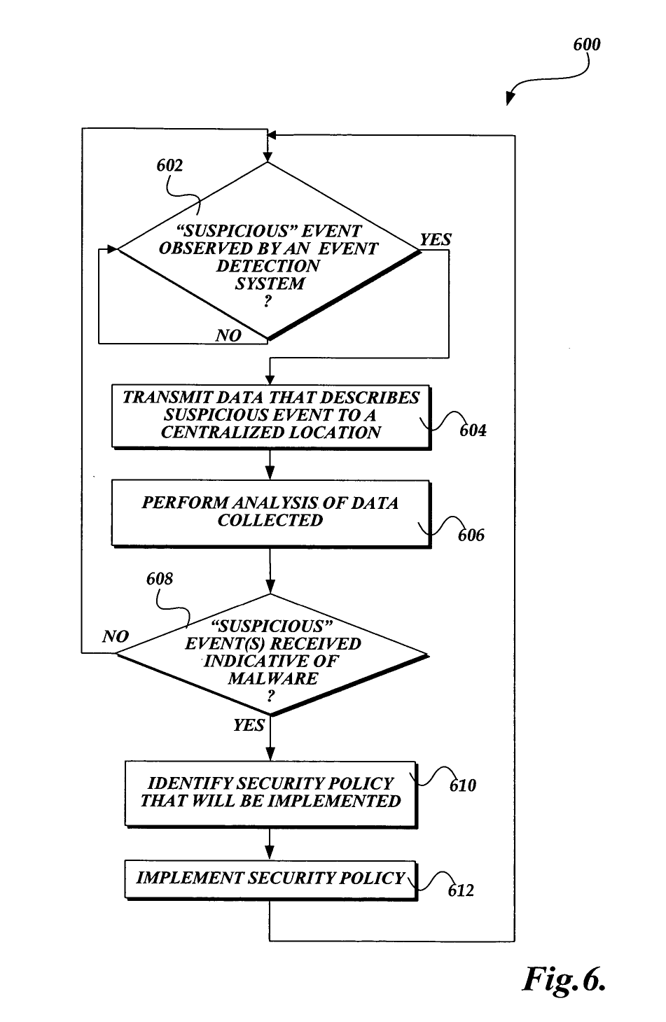

As illustrated in FIG. 4, the event evaluation computer 310 also includes an evaluation component 402. Generally described, the evaluation component 402 both analyzes suspicious events observed in a networking environment and quantifies the likelihood that a network is infected with or under attack by malware. In one embodiment of the present invention, the evaluation component 402 determines whether the number of suspicious events for a given time frame is higher than a predetermined threshold. Also, as described in more detail below with reference to FIG. 6, the evaluation component 402 may analyze metadata generated by event detection systems and calculate a “suspicious score” that represents the probability that a network is infected with or under attack by malware.

Typically, networks in which the present invention may be implemented are configurable to meet the needs of an organization. For example, modern operating systems that allow users to share information in the networking environment typically support mechanisms for managing access to resources. In this instance, users of a network are typically provided with accounts that define the domain of resources a user may access. Similarly, existing operating systems define a computer's role in the network and allow entities to identify and configure the different services provided by a computer.

Aspects of the present invention are also configurable to satisfy the needs of an organization. In this regard, the event evaluation computer 310 maintains an administrative interface 404 for communicating with an administrative entity that establishes policies for a network (e.g., a system administrator). When malware is identified with a sufficient degree of certainty, one or more restrictive security policies that protect computers and/or resources on a network from malware are implemented. As described in more detail below, while default security policies are provided, an administrative entity may configure policies based on the needs of the network. For example, some organizations have “mission-critical” data that is the primary asset of the organization. A system administrator may identify this mission-critical data using the administrative interface 404 and define a security policy that restricts access to the mission-critical data even when malware has not been identified with a high degree of certainty. As a result, when suspicious events in a network occur, all access to the mission-critical data (e.g., read privileges, write privileges, execute privileges, etc.) is prohibited. As a result, any malware that is infecting computers on the network is not capable of performing malicious acts on the mission-critical data.

The administrative interface 404 allows a system administrator to define policies with a variety of preferences. In the example provided above, the mission-critical data is changed to a state that does not allow any type of access. However, the administrative interface 404 allows an administrative entity to define other types of policies that are less restrictive. For example, an administrative entity may define a policy that allows certain types of access to the mission-critical data while prohibiting other types of access. Thus, a system administrator may allow computers on the network to read the mission-critical data while prohibiting the computers from writing or executing the mission-critical data. Similarly, a system administrator may differentiate between computers or users in a policy defined in the administrative interface 404. In this instance, when potential malware is identified, trusted users or computers may be provided with more access to the mission-critical data than others.

As illustrated in FIG. 4, the client computer 302, the messaging/proxy server 308, and the service 320 each maintains a policy implementor 406. As mentioned previously, the evaluation component 402 both analyzes suspicious events observed in a networking environment and quantifies the likelihood that networked computers are infected with or under attack by malware. By quantifying the likelihood of an infection or attack, the present invention is able to implement measured policies that are designed to match the threat posed by a malware. For example, in quantifying the likelihood of an infection or attack, the evaluation component 402 maintains an internal “security level” that represents the perceived threat presented by a malware. As the security level increases, the policies implemented in the networking environment become more restrictive in order to protect the computers and resources in the networking environment.

In general terms, the policy implementor 406 causes two types of policies to be implemented when malware is identified with sufficient certainty. One type of policy restricts access to resources on a network, such as mission-critical data. As described previously, access to the mission-critical data may be restricted in various respects and severity, depending on the threat posed by the malware. However, those skilled in the art will recognize that access to other types of resources may also be restricted. For example, the ability to add computers or user accounts to the network, change passwords, access databases or directories, and the like may be restricted when a potential threat from malware exists.

Another type of policy restricts the ability of a computer that is potentially infected with malware to communicate over the network. As mentioned previously, aspects of the present invention may receive metadata that describes suspicious events observed in the networking environment. The metadata may identify a source (e.g., one or more computers) where the suspicious events are occurring. In this instance, the computer(s) where the suspicious events are occurring may be infected with malware. As result, a restrictive security policy will typically be applied to the computer(s) that restricts the ability of the computer(s) to communicate over the network. In this regard, a policy may block network traffic on specific communication ports and addresses; block communications to and/or from certain network related applications, such as e-mail or Web browser applications; terminate certain applications; quarantine the computer(s) to a certain network with a well-defined set of resources, and block access to particular hardware and software components on the computer(s).

Those skilled in the art and others will recognize that FIG. 4 is a simplified example of one networking environment. Actual embodiments of the computers and services illustrated in FIG. 4 will have additional components not illustrated in FIG. 4 or described in the accompanying text. Also, FIG. 4 shows an exemplary component architecture for implementing aspects of the present invention. Those skilled in the art and others will recognize that other component architectures are possible without departing from the scope of the present invention.

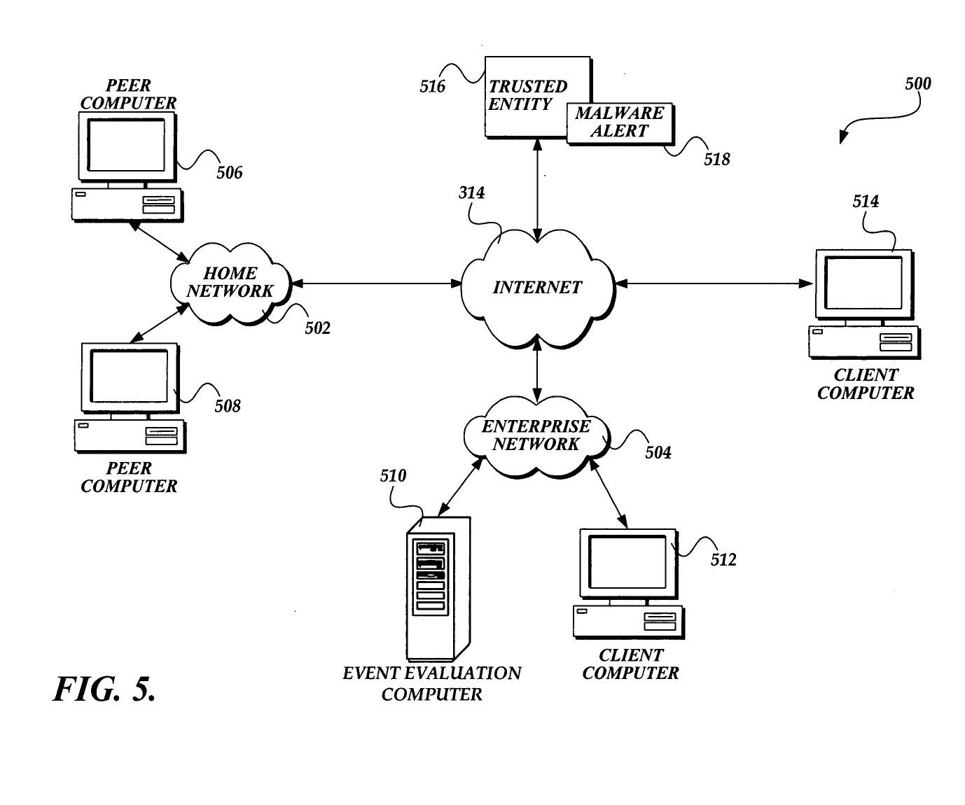

With reference now to FIG. 5, various applications of the present invention will be described in the context of an exemplary networking environment 500. The illustrated networking environment 500 is comprised of three different networks including the Internet 314, the home network 502, and the enterprise network 504. As illustrated in FIG. 5, the home network 502 is communicatively connected to the Internet 314 and includes the peer computers 506 and 508. Similarly, the enterprise network 504 is also communicatively connected to the Internet 314 and includes the event evaluation computer 510 and client computer 512. Also, the networking environment 500 includes the client computer 514 that is connected to the Internet 314.

As described above with reference to FIG. 3, aspects of the present invention may be implemented in a server-based network to proactively protect the network from malware. Similarly, aspects of the present invention may be implemented in a network that maintains “peer-to-peer” relationships among computers, such as the home network 502. In this instance, at least one peer computer in the network serves as a collection point for data that describes suspicious events observed by event detection systems in the network 502. In yet another aspect of the present invention, stand-alone computers or entire networks may “opt-in” to a malware alert system that is managed by a trusted entity 516. As known to those skilled in the art and others, many different software vendors produce antivirus software. Typically, antivirus software is configured to issue a report to a trusted entity 516 when malware is identified. The report is transmitted from a client computer to a server computer that is associated with the trusted entity 516. By receiving these types of reports, the trusted entity 516 is able to quickly determine when a new malware is released on the Internet 314. As a result, the trusted entity 516 may issue a malware alert, with an associated malware security level that is transmitted to computers or networks that “opted-in” to the malware alert system. When the malware alert 518 is received, a restrictive security policy may be automatically implemented that protects the network or stand-alone computer from the malware. Moreover, the trusted entity 516 may issue a malware alert that identifies attributes of a malware found “in the wild”. As described in further detail below, the malware alert generated by the trusted entity 516 may be used to refine the analysis in determining whether a network is infected with or under attack by malware.

Now with reference to FIG. 6, an exemplary embodiment of a method 600 that proactively protects computers in a networking environment from malware is provided.

As illustrated in FIG. 6, the method 600 begins at block 602 where the method 600 remains idle until a suspicious event is observed by an event detection system. Existing antivirus software searches for positive indicators of malware. By contrast, the present invention observes and aggregates data that describes suspicious events that are not positive indicators of malware. As mentioned previously, data that describes the suspicious events is received from disparate event detection systems and evaluated to determine whether the data, taken as a whole, is indicative of malware. Some of the suspicious events that may be observed at block 602 include, but are not limited to, an increase in network traffic, a change in the type of data being transmitted over the network, an increase in the resources used by one or more computer(s) in the network, and an increase in attempts to access sensitive applications or databases such as operating system extensibility points, etc.

At block 604, data regarding the suspicious event observed at block 602 is transmitted to a centralized location that implements aspects of the present invention (e.g., the event evaluation computer 310). Event detection systems on stand-alone computers may be used to observe suspicious events and report the events to a centralized location on the stand-alone computer. In this regard, a detailed explanation of a method, system, and computer-readable medium that collects suspicious events observed on a stand-alone computer and proactively protects the computer from malware may be found in commonly assigned, copending U.S. patent application Ser. No. 11/096,490, entitled “Aggregating the Knowledge Base of Computer Systems to Proactively Protect a Computer from Malware,” the content of which is expressly incorporated herein by reference. However, the present invention is configured to identify suspicious events that occur in a networking environment using disparate event detection systems. Thus at block 604, data that describes the suspicious event observed at block 602 is transmitted to a centralized location. Since systems and protocols for communicating between remote computers are generally known in the art, further description of the techniques used at block 604 to transmit the data will not be provided here. However, as described previously, it should be well understood that aspects of the present invention may actively obtain data that describes the suspicious event from sources such as event logs, databases, and the like. Alternatively, the data may be provided by an event detection system that issues an API call to a software module provided by the present invention (e.g., the collector module 400).

As illustrated in FIG. 6, the method 600 at block 606 performs an analysis on the data collected from the event detection systems. As described previously with reference to FIG. 4, aspects of the present invention quantify the likelihood that a network is infected with or under attack by malware. Those skilled in the art and others will recognize that some suspicious events are more likely to be associated with malware than other suspicious events. In one embodiment of the present invention, the event detection systems in a network are configured to compute a value that represents the probability that one or more suspicious events are associated with malware. For example, a sharp increase in network activity may be assigned a high value by the firewall 318 (FIG. 3), which indicates that a high probability exists that malware is attempting to infect or has already infected one or more computers on the network. Conversely, encountering an encrypted file at the firewall 318 is less likely to be associated with malware and would therefore be assigned a lower value. In accordance with this embodiment, metadata is reported to the collector module 400 (FIG. 4) that represents the probability that a suspicious event is characteristic of malware.

In an alternative embodiment of the present invention, the event detection systems are configured to generate metadata that describes the type of suspicious event observed. In this instance, metadata is obtained by the collector module 400 and the analysis performed at block 606 includes (1) calculating a value that represents the probability that a suspicious event is characteristic of malware from metadata provided by an event detection system, and (2) generating a total value based on all of the suspicious events observed within a predetermined time period.

By collecting metadata that describes the type of suspicious event observed, aspects of the present invention may be used to identify a positive indicator of a malware infection. For example, metadata received from a plurality of event detection systems may indicate that (1) an increase in encrypted data is being received at the network (identified by the firewall 318); (2) the encrypted data is an e-mail message that contains an attachment (identified by the messaging/proxy server 308); and (3) the receipt of the encrypted data is accompanied by an increase in CPU usage from a high percentage of computers on the network (identified by operating systems on a plurality of computers). While observing any one of these events may be innocuous, the combination of events may be associated with malware. Stated differently, a combination of observed events may act as a “signature” that may positively identify a malware.

In either of the embodiments described above, a report that describes a malware generated by a trusted entity may be used to refine the analysis performed at block 606. For example, a trusted entity may identify a new malware and a pattern of events that are associated with the malware. As mentioned above, the pattern of events may be communicated to one or more computers that implement the present invention using a malware alert system. In this instance, events identified in a network where the present invention is implemented that match the pattern of events may be “weighted” (e.g. given a higher degree of significance) than other events when determining whether the network is infected with or under attack by malware.

At decision block 608, the method 600 determines whether the suspicious event(s) analyzed at block 606 satisfy a predetermined threshold indicative of malware. If at least a minimum threshold exists, the method 600 proceeds to block 608 described below. Conversely, if a threshold indicative of malware is not satisfied, the method 600 proceeds back to block 602 and blocks 602 through 608 repeat until the threshold is satisfied.

As illustrated in FIG. 6, at block 610, the method 600 identifies the security policy that will be implemented. As mentioned previously, aspects of the present invention quantify the likelihood that a network is infected with or under attack by malware and sets a security level based on that analysis. If block 610 is reached, a malware was identified with a sufficient degree of certainty that a restrictive security policy will be implemented. In this instance, a generally restrictive security policy will typically be implemented. As mentioned previously, implementing a security policy may include, but is not limited to, restricting access to resources on a network and limiting the ability of computer(s) associated with suspicious events to communicate over the network. Moreover, the restrictions imposed by the security policy will typically be in proportion to the established security level. As a result, the security policy is more restrictive when the likelihood that the network is infected with or under attack by malware is high. Also, an entity that sets policy for a network may define custom policies that are designed to satisfy the specific needs of an organization.

In an alternative embodiment, metadata obtained from the event detection systems is used to identify the restrictive security policy that will be implemented. Metadata may be received at block 604 that describes the type of suspicious event observed. In the example provided above, the event detection systems transmit metadata that indicates (1) an increase in encrypted data is being received at the network; (2) the encrypted data is an e-mail message that contains an attachment; and (3) the receipt of the encrypted data is accompanied by an increase in CPU usage from a significant percentage of computers on the network. At block 610, the metadata received may be used to identify an appropriate policy that will be implemented to protect the network. In this example, the metadata provides a strong heuristic indicator that malware is using e-mail messages to spread. In this instance, the policy identified at block 610 may be driven by the information known about the malware. So, in this example, when the propagation means of the malware is identified, the policy may cause the messaging/proxy server 308 (FIG. 3) to restrict or prohibit the transmission of asynchronous messages from the network.

As illustrated in FIG. 6, at block 612, the policy identified at block 610 is implemented. As mentioned previously, the present invention maintains a software module (e.g., the policy implementor 406) that is included with various computers, computing devices, and computing systems in a networking environment. At block 612, data regarding the restrictive security policy that will be implemented is transmitted from a centralized location (e.g., the event evaluation computer 310) to one or more remote computers, computing devices, or computer systems using techniques that are generally known in the art. Then, as described above with reference to FIG. 4, a restrictive security policy that is designed to protect the networking environment from malware is implemented. Finally, the method 600 proceeds back to block 602 where it remains idle until a suspicious event is observed.

It should be well understood that the restrictive security policy implemented at block 612 may be easily disengaged if a determination is made that malware was incorrectly identified. For example, a system administrator may determine that data identified as malware is, in fact, benevolent. In this instance, the restrictive security policy may be disengaged by a command generated from the system administrator or automatically as a result of future learning.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. In a computer networking environment that includes a plurality of event detection systems and an event evaluation computer communicatively connected to the event detection systems, a method of proactively protecting computers and resources in the networking environment from malware, the method comprising:
(a) using the event detection systems to observe suspicious events that are potentially indicative of malware;
(b) determining whether the suspicious events observed satisfy a threshold indicative of malware; and
(c) if the suspicious events observed satisfy the threshold indicative of malware, implementing a restrictive security policy on the networking environment.

2. The method as recited in claim 1, wherein the restrictive nature of the security policy is configured to be in proportion to the probability that the suspicious events observed are characteristic of malware.

3. The method as recited in claim 1, wherein data that describes the suspicious events is used to identify the restrictive security policy that will be implemented.

4. The method as recited in claim 3, wherein data that describes the suspicious event is reported to the event evaluation computer by an event detection system that issues an application programming interface call to a software component maintained by the event evaluation computer.

5. The method as recited in claim 3, wherein data that describes the suspicious event is obtained from a data store maintained by an event detection system.

6. The method as recited in claim 1, wherein:
(a) the event detection systems are maintained by a trusted entity that detects malware infections on computers connected to the Internet; and
(b) if the trusted entity determines that a malware is spreading over the Internet, implementation of the restrictive security policy is initiated by a malware alert generated by the trusted entity.

7. The method as recited in claim 1, wherein the networking environment is a server-based network in which the event evaluation computer maintains a server-client relationship with other computers, computing devices, or computing systems in the networking environment.

8. The method as recited in claim 1, wherein the networking environment is a peer-to-peer network in which the event evaluation computer maintains a peer-based relationship with other computers, computing devices, or computing systems in the networking environment.

9. The method as recited in claim 1, wherein determining whether the suspicious events observed satisfy a threshold indicative of malware includes:
(a) assigning a value to each suspicious event observed based on the probability the suspicious event is characteristic of malware; and
(b) generating a weighted summation of the values assigned to the suspicious events observed.

10. The method as recited in claim 1, wherein determining whether the suspicious events observed satisfy a threshold indicative of malware includes:
(a) identifying patterns of events that occur when a network is infected with or under attack by malware; and
(b) comparing the suspicious events observed to the patterns of events that are known to occur or indicate a change to normal events when a network is infected with or under attack by malware.

11. The method as recited in claim 1, wherein the restrictive security policy limits access to a resource on the network.

12. The method as recited in claim 1, wherein the restrictive security policy limits the ability of computers in the network to communicate over the network.

13. The method as recited in claim 12, wherein the limits placed on computers imposed by the restrictive security policy include:
(a) blocking network traffic on specific communication ports;
(b) blocking communications involving certain network-based applications;
(c) blocking access to hardware and software components on the computer; and
(d) blocking network traffic involving specific addresses.

14. The method as recited in claim 1, wherein the event detection systems monitor network traffic, e-mail correspondence, computer resource usage, and events generated from application programs or an operating system.

15. A software system that proactively protects a network from malware, the software system comprising:
(a) an evaluation component for determining whether suspicious events observed in the network are indicative of malware;
(b) a plurality of event detection systems operative to observe suspicious events that occur in the network;
(c) a collection module that collects data that describes the suspicious events observed by the event detection systems; and
(d) a policy implementor operative to implement a restrictive security policy when the evaluation component determines that the suspicious events observed are indicative of malware.

16. The software system as recited in claim 15, further comprising an administrative interface for obtaining data from an administrative entity that defines the restrictive security policy that will be implemented.

17. The software system as recited in claim 15, wherein the evaluation component is further configured to set a security level that is based on the probability that the suspicious events or a pattern of events observed are indicative of malware.

18. The software system as recited in claim 17, wherein the restrictive nature of the security policy implemented by the policy implementor is based on the security level set by the evaluation component.

19. A computer-readable medium bearing computer-executable instructions that, when executed on a computer in a networking environment that is communicatively connected to a plurality of event detection systems, causes the computer to:
(a) use the event detection systems to observe suspicious events or a pattern of events that are potentially indicative of malware;
(b) determine whether the suspicious events or a pattern of events observed satisfy a threshold indicative of malware; and
(c) if the suspicious events or a pattern of events observed satisfy a threshold, implement a restrictive security policy on the networking environment.

20. The computer readable medium as recited in claim 19, wherein the computer is further configured to:
(a) assign a value to each suspicious event or pattern of events observed based on the probability the suspicious event is characteristic of malware; and
(b) generate a weighted summation of the values assigned to the suspicious events observed.
